(19) United States
(12) Patent Application Publication
(10) Pub. No.: US 2011/0020045 A1
(43) Pub. Date: Jan. 27, 2011

(54) PRINTING MEDIUM ROLL CLAMPING SUPPORT OF BARCODE PRINTER

(75) Inventor: I Che YU, I-LAN COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: TSC AUDIO ID TECHNOLOGY CO., LTD., TAIPEI CITY (TW)

(21) Appl. No.: 12/788,802

(22) Filed: May 27, 2010

(30) Foreign Application Priority Data
Jul. 22, 2009 (TW) 098213351

(51) Int. Cl. B41J 15/02

(52) U.S. Cl. 400/613

(57) ABSTRACT

A printing medium roll clamping support is provided for use in a barcode printer and includes at least two bases, each having a top forming at least one connection section and at least two positioning sections, and at least two changeover devices, each having opposite surfaces respectively forming a first positioning ring and a second positioning ring. The bases are respectively and movably fit in tracks defined in a housing of the barcode printer to allow the bases to be selectively moved inward for clamping a roll of printing medium or moved outward for releasing the roll of printing medium. Each changeover device has a bottom forming a pivot joint section and at least two positioning elements. The pivot joint section corresponds to and is rotatably coupled to the connection section of the corresponding base so as to allow for selective rotation of the changeover device by 180 degrees to switch between the first positioning ring and the second positioning ring for clamping rolls of printing medium of different diameters. With the positioning elements fit into the positioning sections, the changeover device is securely retained on the top of the corresponding base.

### BACKGROUND OF THE INVENTION

1. Field of the Invention

The present invention relates to a printing medium roll clamping support of a barcode printer, and in particular to a printing medium roll clamping support that comprises changeover devices that are rotatable to switch surfaces thereof for mating and clamping rolls of printing medium f different diameters.

2. The Related Arts

In a conventional barcode printer, a roll of printing labels is received and retained inside the barcode printer to supply the printing labels to a printing mechanism for effecting printing on the labels. The roll is supported and retained by a clamping support mechanism that only works for clamping and supporting label rolls of a fixed diameter and is not suitable to support two different diameters of the label rolls. Clamping support mechanisms of different specifications must be separately provided for retaining and supporting label rolls of different diameters. This increases the manufacturing costs of the label printers. Further, a user of the label printer must stock label rolls of different diameters for different applications of the barcode printer. This is a heavy burden of investment. Apparently, this fact adversely affects the development of the barcode printer industry.

### SUMMARY OF THE INVENTION

The known printing medium roll clamping support of barcode printers is incapable of accommodating printing medium rolls of various diameters and this makes the manufacturing costs of the printer high and thus no economic and adverse against the development of the industry.

To overcome the problems and drawbacks of the conventional devices, the present invention provides a printing medium roll clamping support for use in a barcode printer and comprising at least two bases, each having a top forming at least one connection section and at least two positioning sections, and at least two changeover devices, each having opposite surfaces respectively forming a first positioning ring and a second positioning ring. The bases are respectively and movably fit in tracks defined in a housing of the barcode printer to allow the bases to be selectively moved inward for clamping a roll of printing medium or moved outward for releasing the roll of printing medium. Each changeover device has a bottom forming a pivot joint section and at least two positioning elements. The pivot joint section corresponds to and is rotatably coupled to the connection section of the corresponding base so as to allow for selective rotation of the changeover device by 180 degrees to switch between the first positioning ring and the second positioning ring for clamping rolls of printing medium of different diameters. With the positioning elements fit into the positioning sections, the changeover device is securely retained on the top of the corresponding base.

The efficacy of the printing medium roll clamping support of the present invention is that two changeover devices that can be operated in an easy manner and manufactured with low costs are rotatably coupled to two bases for selective switching between opposite surfaces thereof to allow the changeover devices to clamp rolls of printing medium of different diameter, so as to substantially reduce the manufacturing costs of the barcode printers and to enhance economic value and industrial value of the product of barcode printer.

### BRIEF DESCRIPTION OF THE DRAWINGS

The present invention will be apparent to those skilled in the art by reading the following description of preferred embodiments thereof, with reference to the attached drawings, wherein:

FIG. 1 is a perspective view showing a printing medium roll clamping support constructed in accordance with a first embodiment of the present invention;

FIG. 2 is an exploded view of FIG. 1;

FIG. 3 is a top view of FIG. 2 in an assembled form;

FIG. 4 is an exploded view showing a printing medium roll clamping support constructed in accordance with a second embodiment of the present invention;

FIG. 5 is an exploded view showing a printing medium roll clamping support constructed in accordance with a third embodiment of the present invention;

FIG. 6 is a perspective view illustrating an application of the printing medium roll clamping support of the present invention;

FIG. 7 is a perspective view illustrating a rotation based switching operation of changeover devices of the printing medium roll clamping support of the present invention; and

FIG. 8 is a top view illustrating the rotation based switching operation of the changeover devices of the printing medium roll clamping support of the present invention.

### DETAILED DESCRIPTION OF THE PREFERRED EMBODIMENTS

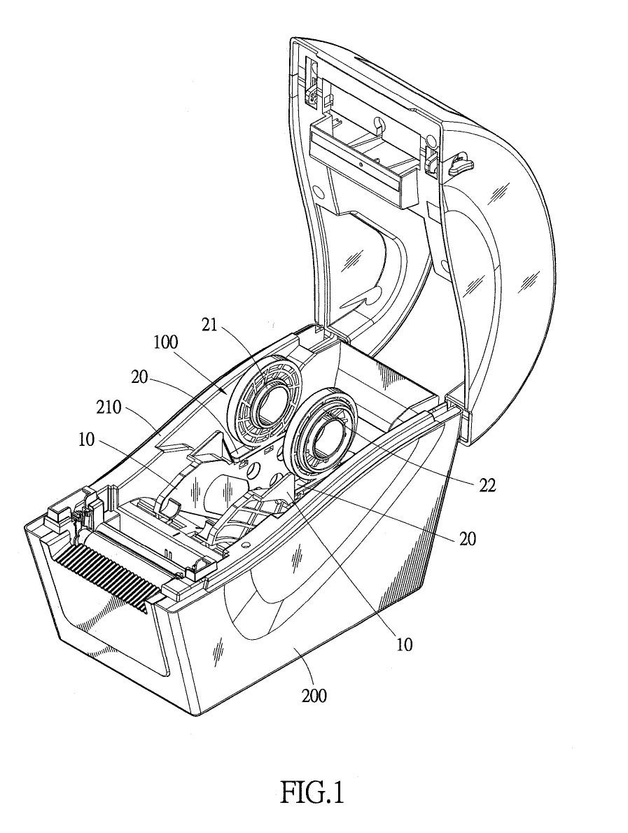

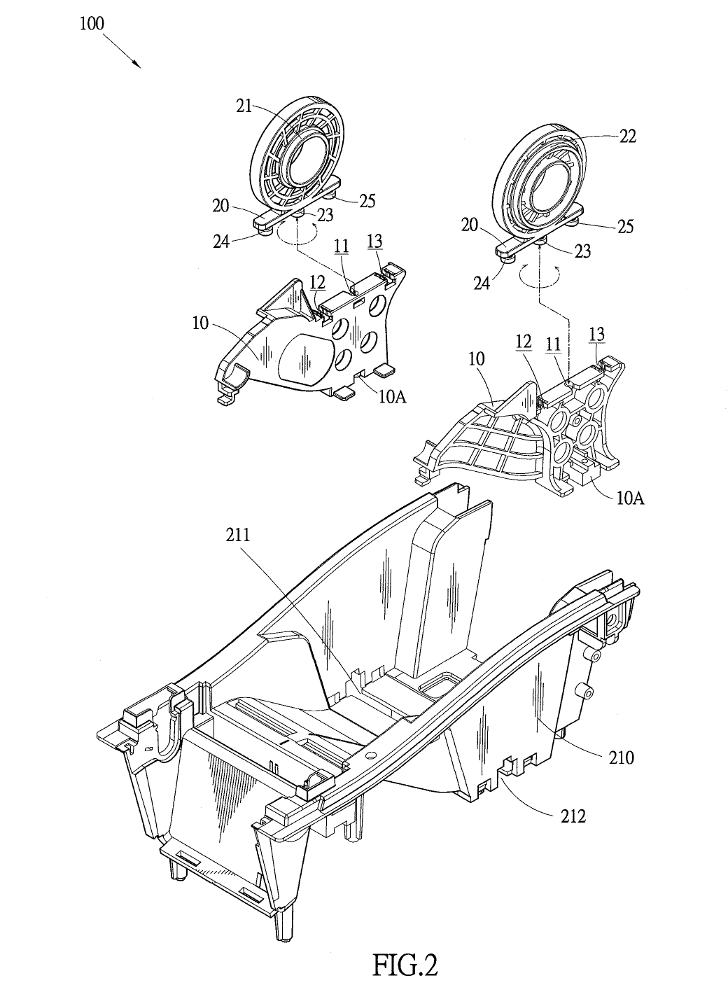

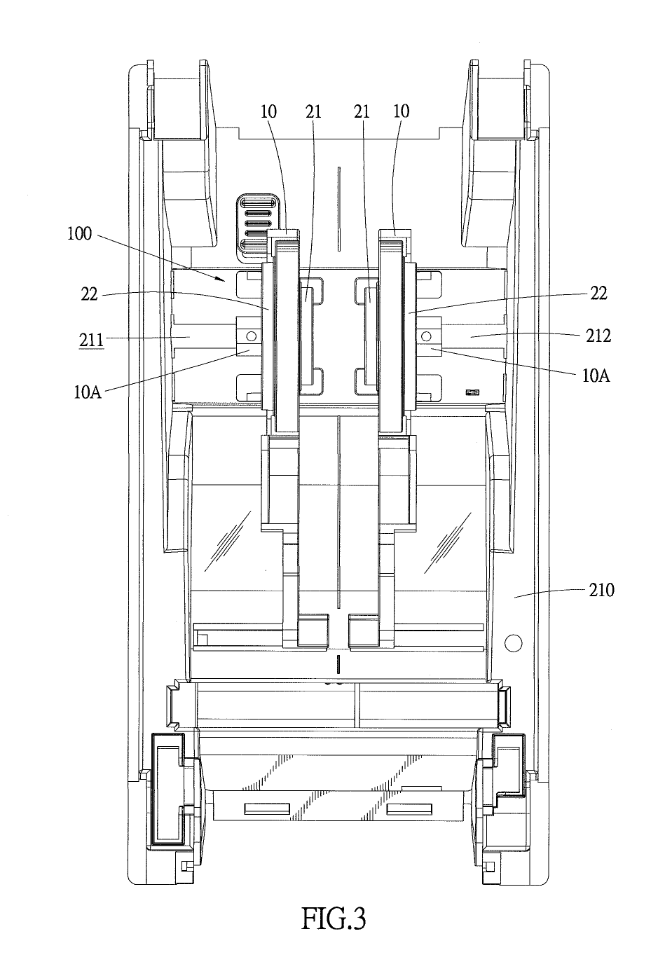

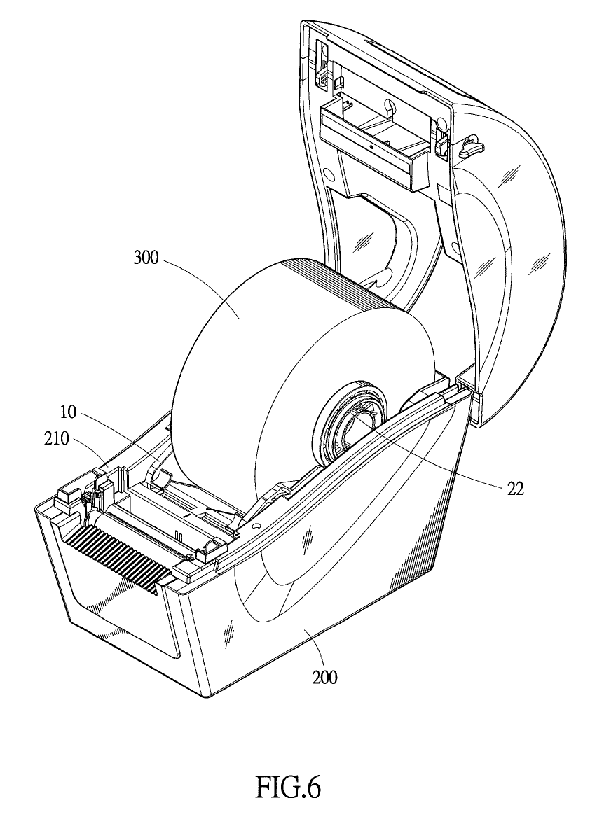

With reference to the drawings and in particular to FIGS. 1-3, a printing medium roll clamping support constructed in accordance with a first embodiment of the present invention, generally designated with reference numeral 100, is shown for use in a barcode printer 200 to securely and stably hold a roll of printing medium 300 (see FIG. 6). The printing medium roll clamping support 100 comprises two bases 10. Each base 10 has a bottom forming a fitting section 10A. The two fitting sections 10A of the two bases 10 are respectively fit to two tracks 211, 212 defined in an inner casing 210 of the barcode printer 200 to allow the bases 10 to be selectively moved inward for clamping the roll of printing medium 300 or moved outward for releasing the roll of printing medium 300. Each base 10 has a top forming at least one connection section 11 and two positioning sections 12, 13. In the embodiment illustrated in FIGS. 1-3, the connection section 11 is set in the form of a notch and the positioning sections 12, 13 are made in the form of slots. The structure that couples each base 10 to the track 211, 212 is not limited to the fitting section 10A that fits into the track 211, 212 and other structures that provide an equivalent function of movably coupling the two is equally applicable and are considered within the scope of the present invention.

At least two changeover devices 20 are provided to respectively correspond to the two bases 10. Each changeover device 20 has a top portion having opposite inside and outside surfaces respectively forming a first positioning ring 21 and a second positioning ring 22. Preferably, the first positioning ring 21 and the second positioning ring 22 have different diameters. Each changeover device 20 has a bottom forming a pivot joint section 23 and at least two positioning elements 24, 25. In the first embodiment illustrated, the pivot joint section 23 is set in the form of a pivot pin corresponding to and rotatably coupled to the connection section 11 of the base 10 so as to allow the changeover device 20 to selectively rotate about the an axis defined by the pivot joint section 23. In the instant embodiment, the positioning elements 24, are made in the form of projecting blocks, which are selectively fit into the positioning sections 12, 13 of the base 10 with the rotation of the changeover device 20 so as to retain the changeover device 20 on the top of the base 10 in a rotation-fixed but releasable manner. In this way, the first positioning rings 21 or the second positioning rings 22 of the inside and outside surfaces of the top portions of the two changeover devices 20 are selectively set to oppose to and thus engage and clamp opposite ends of the roll of printing medium 300.

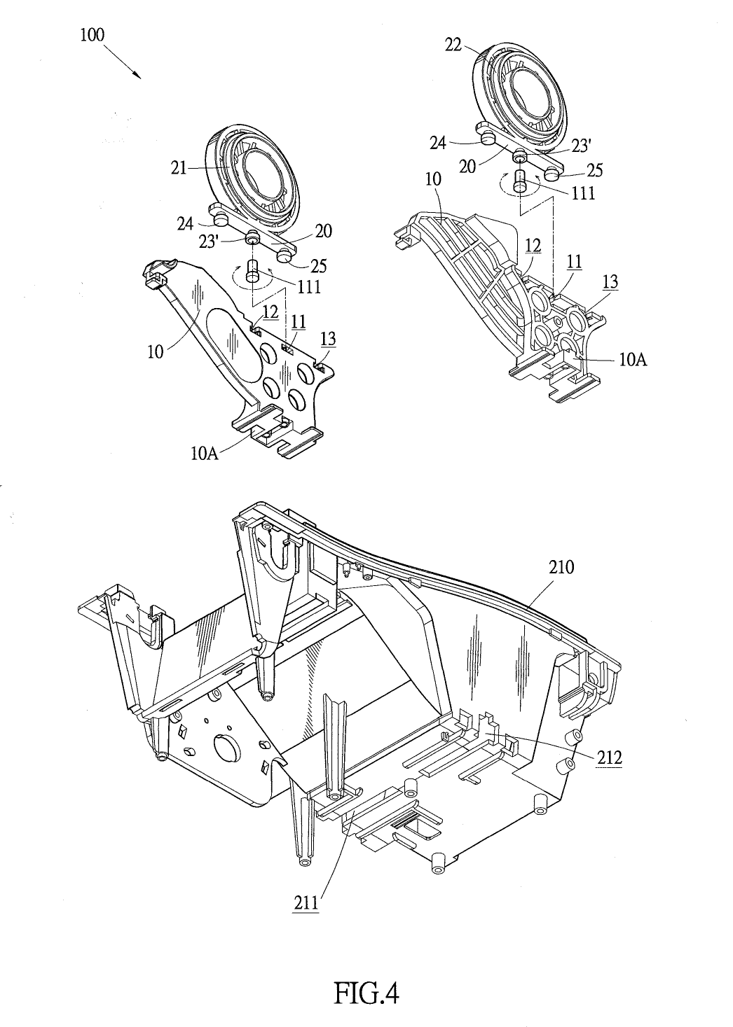

Referring to FIG. 4, a printing medium roll clamping support constructed in accordance with a second embodiment of the present invention is shown and is also designated with reference numeral 100 for simplicity. In the second embodiment of the printing medium roll clamping support, the connection section 11 of each base 10 is provided with a pin 111, which is fit into and retained in the connection section 11. Each changeover device 20 has a pivot joint section, which is designated at 23′ for distinction. The pivot joint section 23′ is made in the form of a bore, which partially receives the pin 111 of the connection section 11 therein to allow the changeover device 20 to selectively rotate about an axis defined by the pin 111.

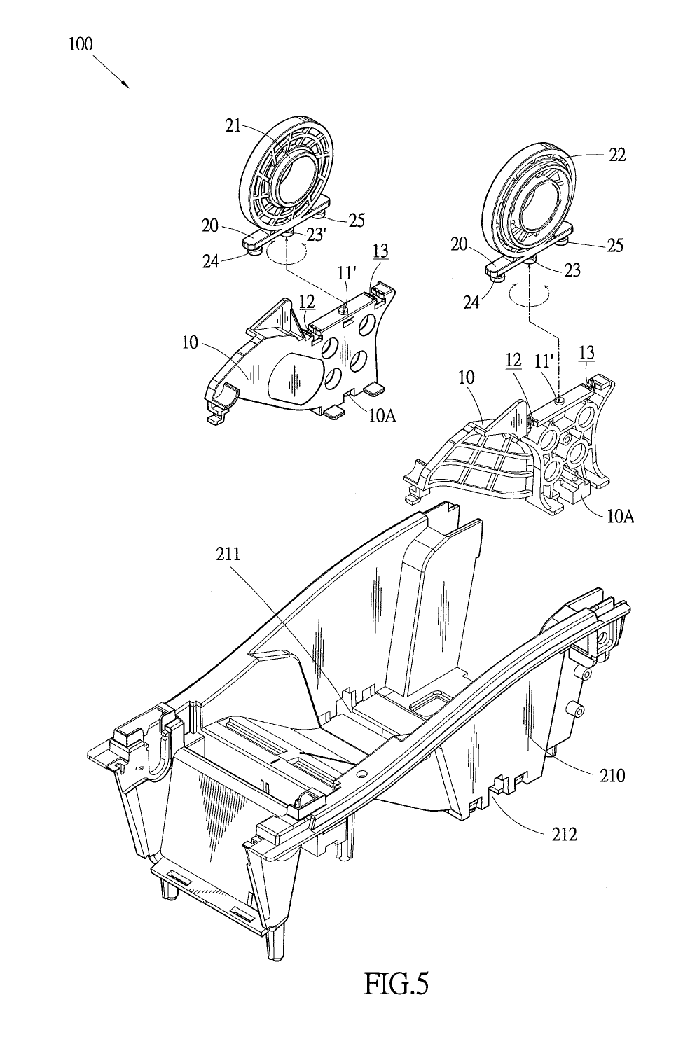

Referring to FIG. 5, a printing medium roll clamping support constructed in accordance with a third embodiment of the present invention is shown and is also designated with reference numeral 100 for simplicity. In the third embodiment of the printing medium roll clamping support, the base 10 has a top forming a connection section, which is designated by 11′ for distinction. The connection section 11′ in made in the form of a cylindrical projection. Each changeover device 20 has a pivot joint section, which is designated at 23′ for distinction. The pivot joint section 23′ is made in the form of a bore, which partially and rotatably receives the connection section 11′ therein to allow the changeover device 20 to selectively rotate about an axis defined by the cylindrical projection of the connection section 11′.

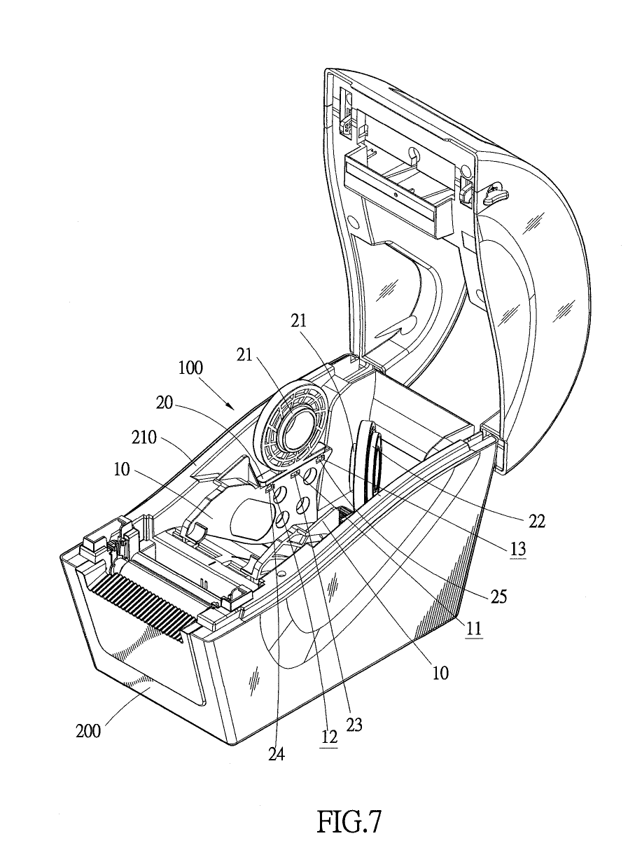

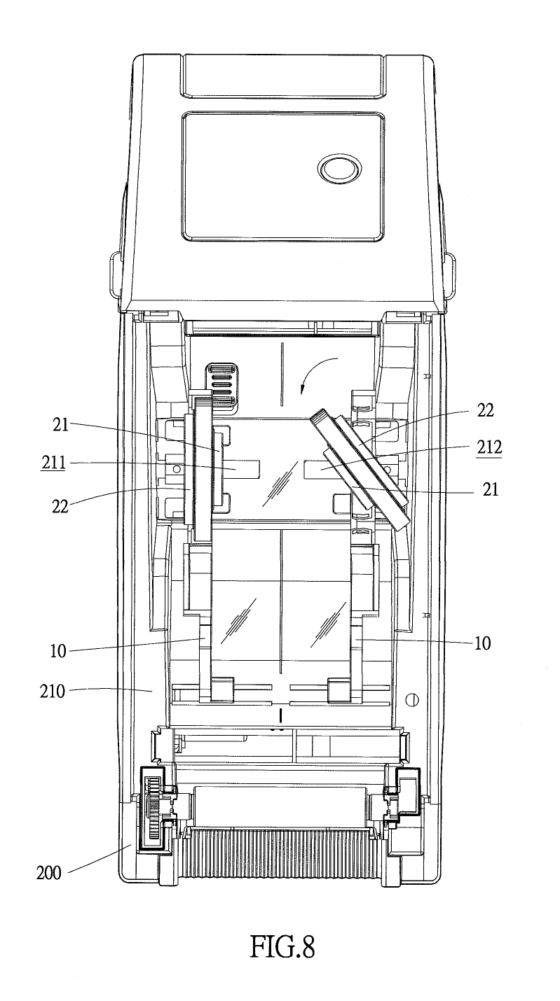

Referring to FIGS. 6 and 7, an application of the printing medium roll clamping support 100 in accordance with the present invention is shown. A roll of printing medium 300 is properly positioned to have opposite ends thereof engaging and clamped by the first positioning rings 21 or the second positioning rings 22 of the top portions of the two changeover devices 20 (as shown in FIG. 6). When an attempt is made to switch to a new roll of printing medium 300 having a different diameter, the two changeover devices 20 are rotated (as shown in FIGS. 7 and 8) to have the positioning elements 24, 25 disengaging from the positioning sections 12, 13 of the bases 10, and the changeover devices 20 are allowed to make a 180 degree turn by which the first positioning rings 21 and the second positioning rings 22 are switched with each other. The positioning elements 24, 25 are then re-fit into the positioning sections 13, 12 of the bases 10 to retain the changeover device 20 in position. In this way, the second positioning rings 22 and the first positioning rings 21 can be selectively used to secure rolls of printing medium 300 of different diameters and thus a function of selectively securing rolls of printing medium 300 of at least two different diameters is realized.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A printing medium roll clamping support for use in a barcode printer, comprising:
at least two bases, which has bottoms respectively fit in tracks defined in the barcode printer to allow the bases to be selectively moved inward for clamping a roll of printing medium or moved outward for releasing the roll of printing medium, each base having a top forming at least one connection section and at least two positioning sections; and
at least two changeover devices, which respectively correspond to the bases, each changeover device having a top portion having opposite inside and outside surfaces respectively forming a first positioning ring and a second positioning ring, each changeover device having a bottom forming a pivot joint section and at least two positioning elements, the pivot joint section corresponding to and rotatably coupled to the connection section of the corresponding base so as to allow for selective rotation of the changeover device about the an axis defined by the pivot joint section to have the positioning elements fit into the positioning sections of the corresponding base to retain the changeover device on the top of the corresponding base, whereby the first positioning rings and the second positioning rings of the top portions of the two changeover devices are selectively set to oppose to and thus engage and clamp opposite ends of the roll of printing medium.

2. The printing medium roll clamping support as claimed in claim 1, wherein the connection section of each of the bases defines a notch.

3. The printing medium roll clamping support as claimed in claim 1, wherein the connection section of each of the bases comprises a pin, which is fit into and retained in the connection section.

4. The printing medium roll clamping support as claimed in claim 1, wherein the connection section of each of the bases comprises a cylindrical projection.

5. The printing medium roll clamping support as claimed in claim 1, wherein the positioning sections each define a slot.

6. The printing medium roll clamping support as claimed in claim 1, wherein the first positioning ring and the second positioning ring have different diameters.

7. The printing medium roll clamping support as claimed in claim 1, wherein the pivot joint section of each of the changeover devices comprises a pivot pin.

8. The printing medium roll clamping support as claimed in claim 1, wherein the pivot joint section of each of the changeover devices defines a bore.

9. The printing medium roll clamping support as claimed in claim 1, wherein the positioning elements of each of the changeover devices comprise projecting blocks.
